(19) United States
(12) Patent Application Publication
(10) Pub. No.: US 2025/0332606 A1
(43) Pub. Date: Oct. 30, 2025

(54) Adjustable Outdoor Area Cooling Misting System

(71) Applicant: Glenn Scalise, Riverside, CA (US)

(72) Inventor: Glenn Scalise, Riverside, CA (US)

(21) Appl. No.: 18/772,491

(22) Filed: Jul. 15, 2024

Related U.S. Application Data
(60) Provisional application No. 63/638,545, filed on Apr. 25, 2024.

(51) Int. Cl. B05B 15/68; B05B 1/20

(52) U.S. Cl. CPC B05B 15/68; B05B 1/20

(57) ABSTRACT

A pool or outdoor area misting device comprising a pair of adjustable telescoping bars, each bar having a base, and a plurality of detachable water carrying connecting rods. The rods are interconnected by misting devices which are capable of swiveling to adjust the spray direction. The system is connected to a water hose, which supplies water through the rods to the misting devices, enabling fine mist to be sprayed over the pool or outdoor area. The misting device features adjustable brass spray heads for controlling mist density and includes filters to maintain cleanliness. The telescoping bars and rods are secured using plastic ties for stability. The bases of the telescoping bars are detachable for easy transportation, and some embodiments include casters on the legs for mobility.

### CROSS-REFERENCE TO RELATED APPLICATION

The present application claims priority to, and the benefit of, U.S. Provisional Application No. 63/638,545, which was filed on Apr. 25, 2024, and is incorporated herein by reference in its entirety.

### FIELD OF THE INVENTION

The present invention generally relates to the field of misting devices. More specifically, the present invention relates to a novel pool or outdoor area misting system for spraying or misting a pool or outdoor area to cool down the pool or outdoor area. The system features telescoping bars to position on sides of a pool, a plurality of water carrying rods are interconnected by misting devices and extend between the top ends of the telescoping bars. The misting devices receive water for spraying mist wherein the water is received from a hose. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals enjoy swimming pools during the summer months for recreation and relaxation. Individuals enjoy a variety of activities in and around the pool or outdoor area, such as pool parties, playing pool volleyball, and lounging in the water. However, while the water remains cool and provides relief from the heat, the upper bodies of pool users that are above the water surface can still become uncomfortably hot.

To avoid such situations, many individuals frequently dip into the water to cool down. In some cases, individuals use garden hoses to pour water over themselves or over the pool or outdoor area to achieve a cooling effect. However, these methods are inefficient and inconvenient. Constantly dipping in and out of the water interrupts the enjoyment of pool activities and manually using hoses can be cumbersome while not providing uniform cooling. Individuals desire a more effective solution to keep pool users cool while enjoying their time in the pool.

Therefore, there exists a long felt need in the art for a pool misting system that solves problems of keeping pool users cool. There is also a long felt need in the art for an innovative pool misting device that provides a constant mist of water on pool users to keep pool users cool. Additionally, there is a long felt need in the art for a special pool misting system that reduces the need for users to take frequent dips into the water to have a cooling effect. Moreover, there is a long felt need in the art for a pool misting device that can be placed around a swimming pool for spraying mist to cool the pool. Further, there is a long felt need in the art for a misting device that sprays mist over pool and that can be connected to a residential garden hose for easy supply of water. Finally, there is a long felt need in the art for a uniquely designed pool misting device that enables individuals to fully enjoy their pool activities without the discomfort of excessive heat.

The subject matter disclosed and claimed herein, in one embodiment thereof, comprises a pool misting device for providing a mist and enhancing the comfort of users over a pool or outdoor area. The pool misting device includes a pair of telescoping bars. A plurality of water carrying cylindrical hollow rods are detachably attached to the top ends of the telescoping bars and are positioned horizontally over the pool. A plurality of misting devices interconnect the water carrying cylindrical hollow rods, each misting device is configured to create and spray mist in different directions and swivel to adjust the direction of the spray. A water hose is coupled to the water carrying connecting rods using a ¼ adapter and is adapted to receive water from a water outlet and pass it through the rods for spraying mist through the misting devices.

In this manner, the pool misting device of the present invention accomplishes all of the forgoing objectives and provides users with a novel misting device that can be placed around a swimming pool to keep pool users cool while they enjoy their time in the pool. The misting device is a practical and user-friendly solution for cooling pool or outdoor areas, enhancing the overall comfort and enjoyment for pool users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pool misting device for enhancing the comfort of users by spraying mist over a pool or outdoor area. The pool misting device includes a pair of telescoping bars, each bar includes a base for providing support and stability. A plurality of water carrying connecting rods are detachably attached to the top ends of the telescoping bars and are positioned horizontally over the pool. A plurality of misting devices interconnect the water carrying connecting rods, each misting device is configured to create and spray mist in different directions and swivel to adjust the direction of the spray, and a water hose is coupled to the water carrying connecting rods and is adapted to receive water from a water outlet and pass it through the rods for spraying mist through the misting devices.

In yet another embodiment, each telescoping bar includes a telescoping knob adapted to rotate to extend or retract an adjustable member, thereby adjusting height of the bar.

In another embodiment, the base of each telescoping bar is detachable and includes at least three legs for providing support on any kind of surface, and wherein the legs optionally have casters disposed thereon.

In another aspect, each misting device includes a hollow body with opposite open ends adapted to receive the water carrying connecting rods, a spray head (i.e., brass spray head) that can be rotated to adjust mist density, and a filter disposed within the misting head to prevent debris or dust from entering the misting system, wherein the filter is replaceable by removing the mist head.

In yet another aspect, a method for spraying mist over a pool or outdoor area to enhance user comfort is described. The method includes the steps of providing a pair of telescoping bars, each with a base for stability and support, a plurality of water carrying connecting rods adapted to connect detachably across top ends of the bars, interconnecting the water carrying connecting rods using a plurality of misting devices, each misting device is configured to spray mist in various directions and swivel to adjust the spray direction, connecting a water hose to the water carrying connecting rods, the hose is adapted to receive water from a water outlet, supplying water through the hose and into the connecting rods, spraying mist through the misting devices to create a cooling effect over the pool or outdoor area, wherein the misting devices include adjustable brass spray heads to control mist density and filters to maintain cleanliness.

In yet another embodiment, the water carrying connecting rods are secured to the telescoping bars using plastic ties to ensure stability and to maintain a consistent misting pattern.

In still another embodiment, the misting device is made of stainless steel and the brass spray head is adapted to be rotated in one direction to increase mist density and in the opposite direction to decrease mist density.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the pool misting device of the present invention in an installed state in accordance with the disclosed structure;

FIG. 2 illustrates an exploded view of the pool misting device of the present invention in accordance with the disclosed structure;

FIG. 3 illustrates an enlarged view of the misting head used in the pool misting system of the present invention in accordance with the disclosed structure;

FIG. 4 illustrates a perspective view showing connection of the water hose with ¼ inch connector in accordance with one embodiment of the present invention; and

FIG. 5 illustrates a perspective view of the pool misting system of the present invention in use for misting a pool in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a exists a long felt need in the art for a pool misting system that solves problems of keeping pool users cool. There is also a long felt need in the art for an innovative pool misting device that provides a constant mist of water on pool users to keep pool users cool. Additionally, there is a long felt need in the art for a special pool misting system that reduces the need for users to take frequent dips in the pool water to have a cooling effect. Moreover, there is a long felt need in the art for a pool misting device that can be placed around a swimming pool for spraying mist to cool the pool, the pool users, and/or the pool deck. Further, there is a long felt need in the art for a misting device that sprays mist over the pool and that can be connected to a residential garden hose for easy supply of water. Finally, there is a long felt need in the art for a uniquely designed pool misting device that enables individuals to fully enjoy their pool activities without the discomfort of excessive heat.

The present invention, in one exemplary embodiment, is a pool misting system for cooling a pool or outdoor area. The system comprising a pair of telescoping support bars, each having a base. A telescoping knob is disposed on each support bar for adjusting the height of the bar. A plurality of water carrying connecting rods, a plurality of misting devices positioned along the connecting rods, each misting device is configured to swivel and adjust the spray direction and includes a brass spray head for controlling mist density. A filter is disposed within each misting device to prevent debris from entering the system, with the filters being replaceable by removing the mist heads.

Reference will now be made in detail to the present preferred embodiments of the invention, examples of which are illustrated in the accompanying drawings. Wherever possible, the same reference numerals are used in the drawings and the description to refer to the same or like parts.

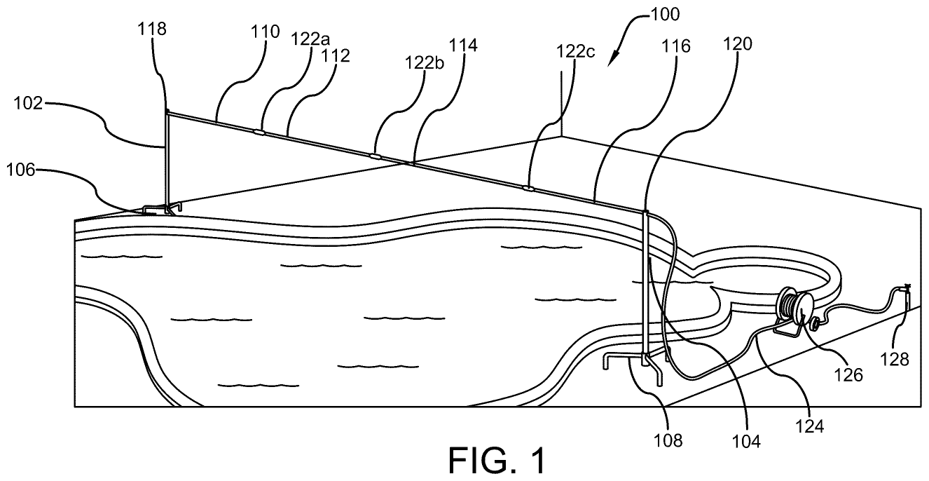

Referring initially to the drawings, FIG. 1 illustrates a perspective view of the pool misting device of the present invention in an installed state in accordance with the disclosed structure. The pool misting device 100 of the present invention is designed to spray mist of water over a surface such as a pool or outdoor area to enhance the comfort of users. More specifically, the pool misting device 100 includes a pair of telescoping bars 102, 104. The first telescoping bar 102 includes a base 106 and the second telescoping bar 104 includes a corresponding base 108. The base 106, 108 provide support and stability to the telescoping bars 102, 104, respectively.

The pool misting device 100 includes a plurality of water carrying connecting rods 110, 112, 114, 116. A water carrying rod 110 from the plurality of rods is detachably attached to top end 118 of the first telescoping bar 102 and another water carrying rod 116 is detachably attached to the top end 120 of the second telescoping bar 104. The water carrying connecting rods 110, 112, 114, 116 are interconnected using misting devices 122a-c (hereinafter referred to as 122) and across the top ends of the bars 102, 104. The misting devices 122 are used for creating and spraying mist in different directions and can also be swiveled or rotated to adjust the direction of the spray.

The adjustable poolside misting system 100 is coupled to a water hose 124 for receiving water to pass through the water carrying cylindrical hollow rods 110, 112, 114, 116 for spraying a mist through the misting devices 122. The water hose 124 can be a component of the device 100. The water hose 124 can be of different lengths and can be rolled onto a portable hose storage device 126. The water hose 124 can be connected to a water outlet 128 for supply of water to the device 100. Depending on pool size or the area for misting, any number of water carrying connecting rods can be used in the adjustable poolside misting system 100 and height of the telescoping bars 102, 104 can be adjusted to meet requirements of different users.

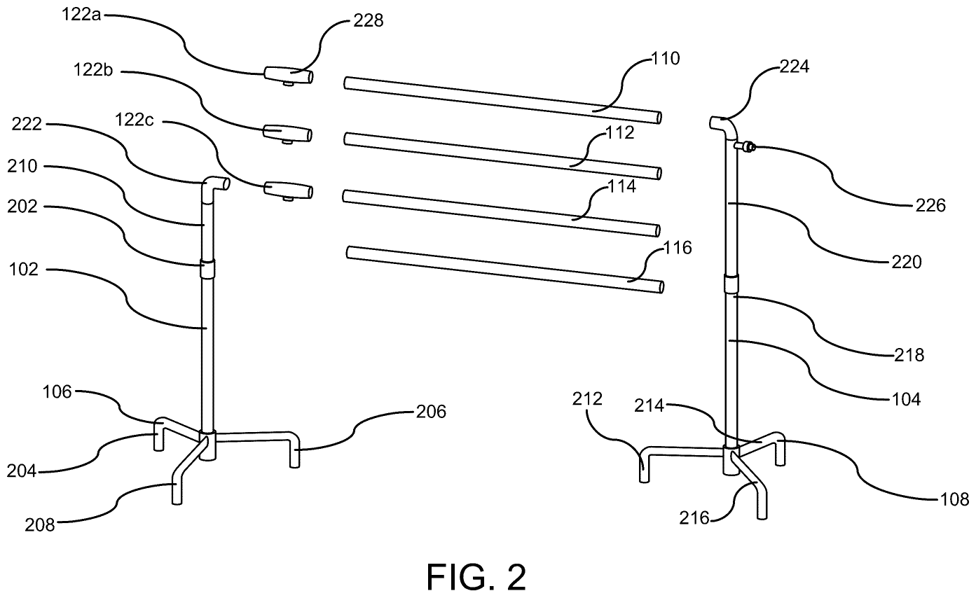

FIG. 2 illustrates an exploded view of the pool misting device of the present invention in accordance with the disclosed structure. As illustrated, the first telescoping bar 102 includes the detachable base 106 and a telescoping knob 202. The base 106 can be detached for easy transportation and storage. The base 106 preferably has three legs 204, 206, 208 for providing support on any kind of surface and in some embodiments, the legs 204, 206, 208 can have casters disposed thereon. The telescoping knob 202 enables a user to adjust the length or height of the first telescoping bar 102 by extending or retracting the adjustable member 210. In the present embodiment, the telescoping knob 202 can be rotated enabling the adjustable member 210 to extend and retract. Similarly, the second telescoping bar 104 includes the base 108 with three legs 212, 214, 216 and the corresponding telescoping knob 218. The telescoping knob 218 can be rotated to adjust the second adjustable member 220.

The top ends 118, 120 includes L-shaped connectors/ties 222, 224 wherein each L-shaped connector is adapted to receive a water carrying connecting rod and a water connector 226. Although, in FIG. 2, water connector 226 is attached to the connector 224 but can also be connected to the connector 222. The water carrying cylindrical hollow rods 110, 112, 114, 116 can be of same length or different lengths and may have same or different diameters. In the preferred embodiment, four rods are provided but there is no limitation on the number of connecting rods.

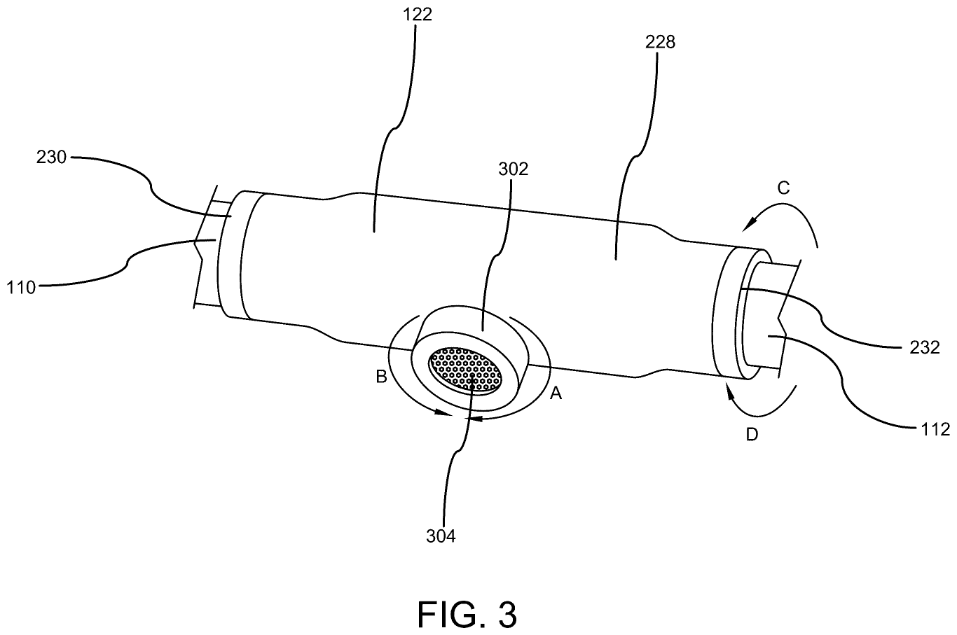

Each misting head 122 has a hollow body 228 with opposite open ends 230, 232 (FIG. 3). The hollow body 228 is adapted to accommodate at least a portion of a connection rod accommodated through at least one open end. The pool misting device 100 is made of a waterproof, corrosion-resistant, durable, and lightweight material. Further, the pool misting device 100 can come in different colors, sizes, and designs to meet the requirements of different users.

FIG. 3 illustrates an enlarged view of the misting head 122 used in the pool misting system of the present invention in accordance with the disclosed structure. The misting head or device 122 is made of stainless steel and has a brass spray head 302. The hollow body 228 receives a first connection rod (such as 110) through the first opening 230 and receives a second connection rod (such as 112) through the second opening 232. Similarly, all the misting heads receive corresponding connection rods in the respective openings. The hollow body 228 can be rotated manually to adjust position of the brass spray head 302 to orient the mist spray in a desired direction. The brass spray head 302 can be rotated in one direction (Arrow A) to increase the mist density and can be rotated in the opposite direction (Arrow B) to decrease the mist density. The misting head can be designed in different sizes and to be compatible with different mist densities.

The misting head 302 includes a filter 304 disposed therein for preventing any debris or dust in the mist. The filter 302 is adapted to be replaced and can be removed after removing the mist head 302.

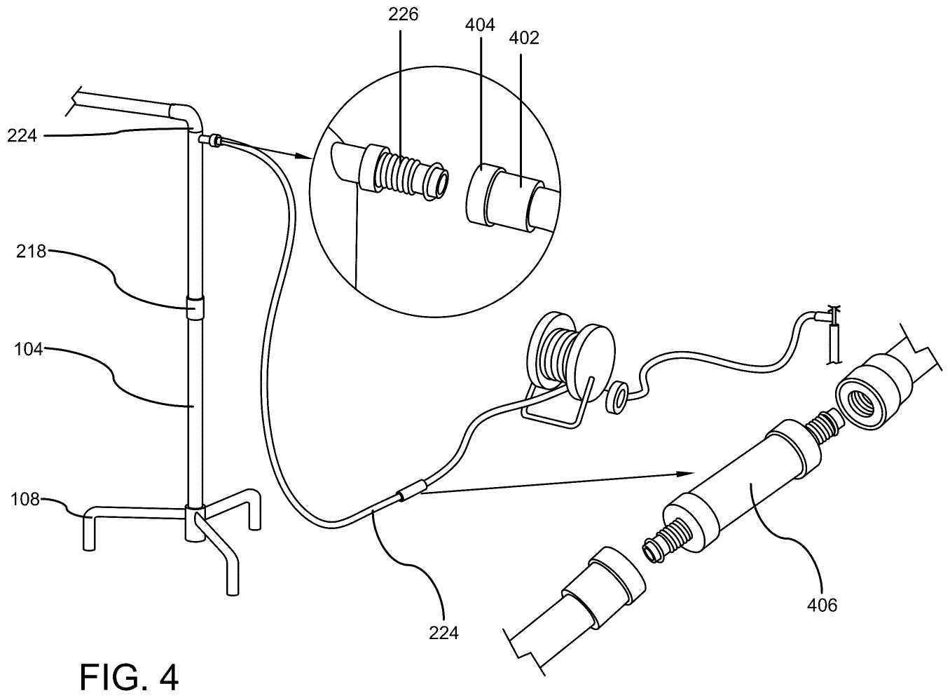

FIG. 4 illustrates a perspective view showing connection of the water hose 124 with a ¼ inch connector in accordance with one embodiment of the present invention. The first end 402 of the hose 124 includes a hose connector 404 which is adapted to be detachably attached to the ¼ inch connector 226. The water received by the ¼ inch connector 226 is adapted to carry along the connection rods 110, 112, 114, 116 for dispensing as mist through the misters 122a-c. The water hose 124 can include a two-ended adapter 406 for enabling water to easily transmit through the water hose 124 even during long distances.

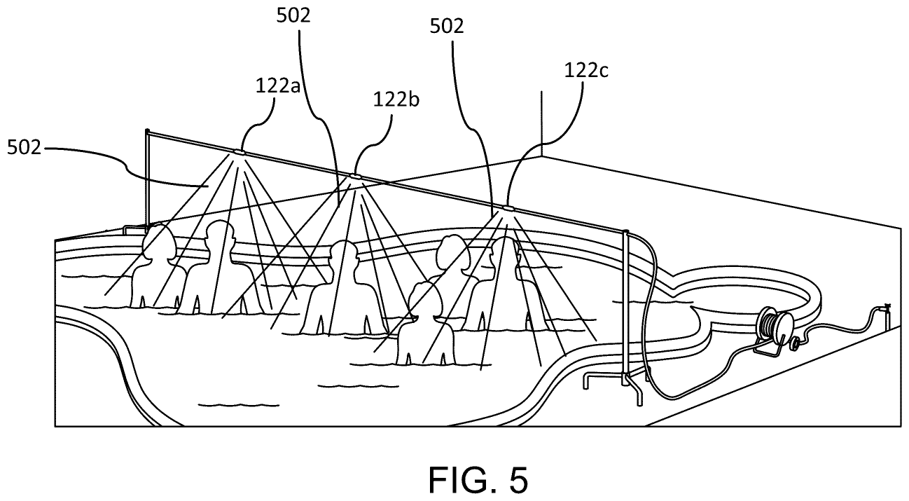

FIG. 5 illustrates a perspective view of the pool misting system of the present invention in use for misting a pool in accordance with the disclosed structure. In the installed state, the water supply can be activated by the water source 128. The water is carried by the hose 124 to the connection rods 110, 112, 114, 116 and mist 502 is sprayed from the misters 122 to enhance the comfort and enjoyment of the users. Each mister 122 is adapted to spray fine mist and can provide mist encompassing an angle of 150 degrees (arrow C to arrow D) for providing complete coverage of a portion of a target area.

The pool misting system 100 of the present invention can cool the pool or outdoor area or any other area by spraying a fine mist. The fine mist helps reduce the temperature in and around the pool or outdoor area, making it more comfortable for users.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adjustable poolside misting system”, “pool misting system”, “pool misting device”, “telescopic pool cooling misting device”, and “device” are interchangeable and refer to the adjustable pool cooling misting system 100 of the present invention.

Notwithstanding the forgoing, the adjustable pool cooling misting system 100 of the present invention can be of any suitable size and configuration as is known in the art without affecting the overall concept of the invention, provided that it accomplishes the above stated objectives. One of ordinary skill in the art will appreciate that the adjustable pool cooling misting system 100 as shown in the FIGS. are for illustrative purposes only, and that many other sizes and shapes of the adjustable pool cooling misting system 100 are well within the scope of the present disclosure. Although the dimensions the adjustable pool cooling misting system 100 are important design parameters for user convenience, the adjustable pool cooling misting system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A misting device to spray mist of water over an outdoor area comprising:
a first telescoping bar;
a second telescoping bar;
a plurality of water carrying connecting rods;
a plurality of misting devices; and
a water hose;
wherein said first telescoping bar having a first base;
wherein said second telescoping bar having a second base;
wherein each pair of said plurality of water carrying connecting rods interconnected with at least one of said plurality of misting devices;
wherein said plurality of water carrying connecting rods and said plurality of misting devices interconnected between said first telescoping bar and said second telescoping bar; and
further wherein said water hose connected to said plurality of water carrying connecting rods for transporting water to said water carrying connecting rods and said plurality of misting devices.

2. The misting device to spray mist of water over an outdoor area of claim 1, wherein a first water carrying connecting rod selectively attached to one of said first telescoping bar and said second telescoping bar.

3. The misting device to spray mist of water over an outdoor area of claim 2, wherein a second water carrying connecting rod selectively attached to another one of said first telescoping bar and said second telescoping bar.

4. The misting device to spray mist of water over an outdoor area of claim 1, wherein said plurality of misting devices selectively rotatable for adjusting a mist spray direction from said plurality of misting devices.

5. The misting device to spray mist of water over an outdoor area of claim 4, wherein said first telescoping bar having a first telescoping knob for selecting a height of said first telescoping bar.

6. The misting device to spray mist of water over an outdoor area of claim 5, wherein said second telescoping bar having a second telescoping knob for selecting a height of said second telescoping bar.

7. The misting device to spray mist of water over an outdoor area of claim 6, wherein each of said plurality of misting devices having a hollow body and opposing open ends.

8. The misting device to spray mist of water over an outdoor area of claim 7, wherein each of said plurality of misting devices having a rotatable spray head for adjusting a mist spray density from each of said plurality of misting devices.

9. The misting device to spray mist of water over an outdoor area of claim 8, wherein each of said plurality of misting devices manually rotatable.

10. The misting device to spray mist of water over an outdoor area of claim 9, wherein said rotatable spray head is manually rotatable.

11. The misting device to spray mist of water over an outdoor area of claim 10, wherein said rotatable spray head having a filter for prohibiting debris from entering said plurality of misting devices.

12. A misting device to spray mist of water over an outdoor area comprising:
a first telescoping bar;
a second telescoping bar;
a plurality of water carrying connecting rods;
a plurality of misting devices; and
a water hose;
wherein said first telescoping bar having a first base;
wherein said second telescoping bar having a second base;
wherein each pair of said plurality of water carrying connecting rods interconnected with at least one of said plurality of misting devices;
wherein said plurality of water carrying connecting rods and said plurality of misting devices interconnected between said first telescoping bar and said second telescoping bar;
wherein said water hose connected to said plurality of water carrying connecting rods for transporting water to said water carrying connecting rods and said plurality of misting devices; and
further wherein each of said plurality of misting devices having a rotatable spray head for adjusting a mist spray density from each of said plurality of misting devices.

13. The misting device to spray mist of water over an outdoor area of claim 12, wherein a first water carrying connecting rod selectively attached to one of said first telescoping bar and said second telescoping bar.

14. The misting device to spray mist of water over an outdoor area of claim 13, wherein a second water carrying connecting rod selectively attached to another one of said first telescoping bar and said second telescoping bar.

15. The misting device to spray mist of water over an outdoor area of claim 14, wherein said plurality of misting devices selectively rotatable for adjusting a mist spray direction from said plurality of misting devices.

16. The misting device to spray mist of water over an outdoor area of claim 15, wherein said first telescoping bar having a first telescoping knob for selecting a height of said first telescoping bar.

17. The misting device to spray mist of water over an outdoor area of claim 16, wherein said second telescoping bar having a second telescoping knob for selecting a height of said second telescoping bar.

18. The misting device to spray mist of water over an outdoor area of claim 17, wherein each of said plurality of misting devices having a hollow body and opposing open ends.

19. The misting device to spray mist of water over an outdoor area of claim 18, wherein each of said plurality of misting devices manually rotatable.

20. A misting device to spray mist of water over an outdoor area comprising:
a first telescoping bar;
a second telescoping bar;
a plurality of water carrying connecting rods;
a plurality of misting devices; and
a water hose;
wherein said first telescoping bar having a first base;
wherein said second telescoping bar having a second base;
wherein each pair of said plurality of water carrying connecting rods interconnected with at least one of said plurality of misting devices;
wherein said plurality of water carrying connecting rods and said plurality of misting devices interconnected between said first telescoping bar and said second telescoping bar;
wherein said water hose connected to said plurality of water carrying connecting rods for transporting water to said water carrying connecting rods and said plurality of misting devices;
wherein each of said plurality of misting devices having a rotatable spray head for adjusting a mist spray density from each of said plurality of misting devices;
wherein said plurality of misting devices selectively rotatable for adjusting a mist spray direction from said plurality of misting devices; and
further wherein each of said plurality of misting devices manually rotatable.
